(19) United States
(12) Patent Application Publication
(10) Pub. No.: US 2011/0106596 A1
(43) Pub. Date: May 5, 2011

(54) System and Method of Generating Postal Mailers for Free

(75) Inventor: Rodger Cosgrove, Riverside, CA (US)

(73) Assignee: Rodger Cosgrove, Riverside, CA (US)

(21) Appl. No.: 12/916,029

(22) Filed: Oct. 29, 2010

Related U.S. Application Data
(60) Provisional application No. 61/256,087, filed on Oct. 29, 2009.

(51) Int. Cl. G06Q 30/00; G06Q 50/00

(52) U.S. Cl. 705/14.4; 705/1.1

(57) ABSTRACT

The present specification discloses a method for generating a plurality of mailers, wherein the system includes a computer open to receive a plurality of mailer demands from a plurality of users via electronic communication. The system includes physically generating each mailer according to each mailer demand by each user, performing at least one work share process to qualify a plurality of mailers for a discount postage rate, and, delivering the plurality of mailers to a postal authority with sufficient postage for delivery to each mailer addressee. Each user may demand a minimum of one mailer and is charged no more than consumer postage rate for each mailer. The cost to generate the mailer and deliver the mailer to the postal authority is less than the charge to the user for the mailer.

This application claims priority to U.S. Provisional Application 61/256,087, filed Oct. 29, 2010, incorporated entirely by reference.

### BACKGROUND

Systems currently exist for generating mailers. Examples of systems are described in U.S. Pat. No. 6,135,292 to Gabriel Pettner, issued Oct. 24, 2000, titled “Method and system for presorting mail based on mail piece thickness,” and U.S. Pat. No. 7,369,918 to Rodger Cosgrove, issued May 6, 2008, titled “System and Apparatus for Generating Mailers on Demand,” both incorporated entirely by reference. There is a need for a less expensive option for users to generate and send postal mailers.

### DESCRIPTION

Definitions: The following words and terms used herein have the following definitions.

“Mailer” means a physical document sent through a postal service and targeted to an addressee. A mailer may be a letter of one or more pages enclosed within an envelope. A mailer may also be a post card, large envelope, etc.

“Consumer postage rate” means the ordinary retail rate for a user to send a single mailer. In the United States, this includes First Class postage and as of November 2009 was: $0.28 for a post card (minimum: 3½ inches high by 5 inches long by 0.007 inch thick, maximum: 6 inches long by 4¼ inches high), $0.44 for a letter up to one ounce (rectangular; length is the dimension parallel to the address, at least 3½ inches high by 5 inches long by 0.007 inch thick; no more than 6⅛ inches high by 11½ inches long by ¼ inch thick); and $0.88 for large envelopes up to one ounce (rectangular, no more than 12 inches high by 15 inches long by ¾ inches thick, and must not be rigid and must be uniformly thick).

“Discount postage rate” or “Work Share Discount” means the rate charged a user who obtains a bulk rate or pre-sort permit from the postal authority and employs work sharing methods with that postal authority. The requirements the user must comply with in order to qualify for the discount postage rates are set forth in the United States by the United States Postal Service's Domestic Mail Manual. Such discounts are provided, for example, to users who send at least 500 First Class mailers and presort their mailers for ease of processing by a postal authority, checking the address against the National Change of Address list, using Intelligent Mail barcode, etc.

“Document” means a custom printed communication, usually printed on flat paper or other substrate and may include graphic design, text or data.

“Electronic communication” means an electronic transmission of information that has been encoded digitally, such as for storage and processing by computers. An electronic communication may be received by the system from any physical location. Ways of electronic communication includes, but are not limited to, e-mail, web servers, web sites, FTP transfer, cell phones, personal digital assistances, computer print drivers, etc.

“Mailer Demand” means input into the system from a user that specifies the desired format of the mailer, e.g., an envelope enclosed document or a postcard and all the data and targeting or addressing data necessary to generate the desired mailer. The mailer demand may come through any electronic communication.

“User” means any natural person, business or other party, or even an automated system.

Although there are other web-to-print-to-mail providers in business today, none of them provide their products for a price that is effectively zero, or “free” to the user.

There are currently businesses that post large volumes of pre-sorted mail have been able to enjoy lower postage charges than the normal retail cost of postage, which combined with the cost of manufacturing the mailer could result in a total cost per unit that is at or below the consumer, retail charge for postage. However, these mailers are not aggregating a plurality of demands for different mailer compositions into a production queue that affords the conventional retail user a price that is effectively free for the processes of composing, manufacturing, and posting the user's mailer.

There are currently organizations who are in the business of commingling mail from a plurality of mail users to achieve higher postal pre-sort densities to qualify for reduced postage charges from the postal service and then sharing the resulting postal savings with their customers. However, these businesses do not manufacture the mail or aggregate the manufacturing into a common production queue that provides sufficient economies to offer the composition, manufacture and posting of the mailers for “free.”

In summary, there has never been a process that provided a turnkey service of composing, manufacturing and posting a mailer for users where the cost of goods sold was covered strictly from the difference between retail, consumer postage rates and wholesale, pre-sort postage rates so that the retail user could get a mailer for zero marginal cost beyond the charge for retail postage while at the same time the service provider enjoys a profit.

In marketing, one of the most powerful motivating forces is getting something for “free.” Newly emerging business models, especially those that are internet based such as Google.com, Facebook.com, Weather.com, etc., currently leverage the power of “free” to enable their business processes. The current invention allows for the generation of a mailer for “free” after the user pays no more than the consumer postage rate for the mailer. At the same time, the system still allows a profit on each mailer by generating the mailer and delivering the mailer to a postal authority after performing at least one work share process to qualify a plurality of mailers for a discount postage rate. For example, if the user pays the current consumer postage rate of $0.44 for First Class postage alone, the system aggregates this mailer demand with those of other users to qualify the system for a current discount postage rate between $0.332 and $0.38.2, depending on the postal sortation density and other factors. In this example, if the weighted average postage per mailer were $0.35, then the difference between the user's payment of $0.44 minus the pass through cost of the discount postage rate cost of $0.35 would yield the system a gross revenue of $0.09 per mailer unit, and a cost of goods sold for the system of less than the $0.09 revenue would yield a gross profit by the difference. The system does not rely upon alternate payment sources, such as the sale of the user's personal information to third parties to pay for the generation and delivery of the mailer. Neither does it rely on advertising charges or other ancillary revenue for operating costs and profits.

A user may send a demand to the system for a mailer. Users could access the invention from any physical location given some channel, e.g., web servers, web sites, email, FTP transfer, or print drivers to communicate appropriately. For example, the user could also be an automated process creating demands through a web server, e.g., a sales transaction at an automated point-of-sale system triggers a demand for a “thank you” letter. A user may send the demand to the system via: Outlook® or other email editing programs; an application or other program on a social network site such as Facebook® or MySpace®; an iPhone® or iPod® application; a Blackberry® application, or other cell phone application; a personal digital assistance; etc.

The user may be billed via a preexisting account, a bank card, a credit card, an iTunes® store account, PayPal account, etc. In one embodiment, the user may set up account and debit each mailer from the account. In another embodiment, for accounts below a predetermined level a service fee may be added to cover transaction fees so that a profit may be obtained for the mailer while still providing the letter generation for “free.” In another embodiment, users may be given a discount for a number of mailers for providing personal information. In another embodiment, a user may be given a discount for allowing advertisements on the mailer, for example, on an envelope, a document, the front of a post card, etc.

The system may include a reward program based upon number of mailers generated by the user over time, and from other users referred by the first user. The reward system may include non-monetary rewards for usage of social network application or monetary rewards over time. Referring organizations may collect a commission by having its members or supporters, for example a political party, use the system.

Many possible uses for the present invention exist. Examples include, but are not limited to: retail transaction triggers CRM software to send a marketing letter; Cub Scouts sending out a letter to everyone in a troop; agent based sales organization's agents send letters to clients; credit granting companies send “turn down” letters or other mandated communications; medical office sending out post cards to remind patients of appointments or letters with invoices; and intercontinental or other long distance mail.

In one aspect of the invention, when an address appears on the national change of address list, the system automatically generated the mailer with the correct address. The user may be notified of the change of address.

In one aspect of the invention, distance is physically eliminated except with respect to the recipient's proximity to a production center. A user may be in a country outside the addressee country, where the mailer is generated within addressee country. Also, a mailer may be generated local to addressee where the user and the addressee are more physically distanced. For example, a user may be in California and an addressee in New York and the mailer could be generated near New York. Clear advantages for local production of the mail is faster arrival and a decrease in logistical burdens including the carbon load for mailer delivery.

In one aspect of the invention, an Intelligent Mail Barcode may be placed on the mailer and used to track the mailer through the postal system. A confirmation message may be sent to the user when the mailer receives a destination confirmation.

In one aspect of the invention, the user could generate a mailer through a channel such as a telephonic voice activated command system similar to functions provided by VoiceAssist™ or other voice command systems whereby the user is not immediately able to review the appearance and composition of the mailer. In this event, rather than immediately launch the mailer by the voice activated command, the user may instruct the system to send an electronic proof such as an email presented in HTML with a PDF® file attached whereupon, after being reviewed by the user, the user may authorize the physical manufacture and mailing through the postal service of the mailer. In another embodiment, the user may edit the digital version of the mailer before authorizing its physical manufacture and mailing. In one embodiment, authorization may be giving by activating a linking button within the email.

In one aspect of the invention, after a mailer is physically produced a line scan video camera or similar device could create an image of the mailer before it is entered into the postal mail stream to provide a digital record of the mailers physical appearance. This digital image could be time stamped and entered into a database so that together with the image the user would have an audit trail of the manufacture and posting of the mailer, which record could be correlated with other records such as the initial user demand for production and/or any digital proof of the mailer.

In one aspect of the invention, a computer program could present a user interface similar to that provided by a program such as Microsoft's Outlook whereby the user could keep a record of each demand for a mailer and the mailer's associated proofs, time stamps, scanned images, etc. in a format that allows for easy retrieval and sorting of digital versions or copies of a mailer according to various criteria such as date, subject or recipient.

In one aspect of the system, a computer program, for example a word processor, that normally generates a digital document to be sent to a printer to physically print the document by means of a secondary computer program typically called a “print driver” could be provided with yet another computer program, a “pseudo-print driver,” that would emulate a printer driver, but instead of sending the document data to a local or network printer would instead enable a demand through the internet to have the document produced as a mailer by the current invention.

In one aspect of the invention, computer software could automatically make demands for a mailer triggered by reference to a database or some programmed event, for example a financial statement or calendared appointment, that is managed by the software.

### EXAMPLES

### Example 1

### Medical Office

Currently a medical or dental office will often use a reminder system of either phone calls and/or a postcard sent to patients to remind them of an imminent appointment with a doctor or dentist. Typically the calendar used to manage these appointments is a function of a software program used to manage the professional practice. Using the current invention, the software program could automatically generate a demand for a reminder mailer. In the case where the reminder is a postcard, for example, the user would be charged only the current consumer postage rate, $0.28 as of November 2009, and would save the additional costs of printing and labor conventionally associated with sending a postcard reminder. If the cost of manufacturing of the postcard in a commercial digital lettershop environment, the cost of goods sold, were $0.02 and the discount postage rate, ranging from $0.202 to $0.23 as of November 2009, were a weighted average of $0.21 then the net revenue to the system would be the difference between the consumer postage rate of $0.28 and the discount postage rate of $0.21, or $0.07. Therefore the revenue of $0.07 per unit less the cost of goods sold of $0.02 would yield a gross margin of $0.05 per mailer.

### Example 2

### Referring Organization

Organizations such as a school, fraternal club, church, political party, charity, etc. could refer its members to a service employing the current invention for consideration of a share of the gross margin. For example, the Boy Scouts of America® could refer its members to an internet portal or other channel to a service employing the current invention in order to realize a commission of $0.01 for each mailer demanded through the referring channel.

### Example 3

### Automobile Dealerships

It is currently common practice for automobile dealerships to use a reminder system of either phone calls and/or a postcard sent to customers or other parties known to own a car of the marquee of the dealer to remind them get their car serviced by the dealer. Typically the data used to generate these reminders is a function of a software program commonly called a “DMS” (dealer management system) used to manage the dealership's business affairs including its customer records. Using the current invention, the DMS could automatically generate a demand for a reminder mailer, or alternatively the system of the current invention could poll the DMS for the pertinent data to be employed for demand of reminder mailers. In this case where the reminder is a postcard, for example, the financial dynamics would be similar to those of Example 1 above concerning a medical office, thereby saving the dealer the conventional labor and production costs of sending a reminder.

### Example 4

### Social Media Interface

Users of internet social media such as Facebook®, Linkedln®, or other such services currently only have the option of sending digital messages. However, using the current invention it would be possible to send physical mailers, for example a birthday greeting or a professional resume, with a computer program that links a social media record to the system.

### Example 5

### Accounting System

Currently users of accounting software such as Intuit's QuickBooks® typically generate an invoice, statement or other financial document to be rendered by email or physically printed on a local printer. The current invention would enable such documents to be produced remotely and mailed to recipients much faster and more economically than by the conventional process.

1. A method for generating a plurality of mailers, comprising:
a) a system comprising a computer open to receive a plurality of mailer demands from a plurality of users via electronic communication,
b) physically generating each mailer according to each mailer demand by each user,
c) performing at least one work share process to qualify a plurality of mailers for a discount postage rate, and,
d) delivering the plurality of mailers to a postal authority with sufficient postage for delivery to each mailer addressee,
e) wherein each user may demand a minimum of one mailer,
f) wherein user is charged no more than consumer postage rate for each mailer, and
g) wherein the cost to generate the mailer and deliver the mailer to the postal authority is less than the charge to the user for the mailer.

2. The method of claim 1, wherein at least 500 mailers are aggregated by the system before performing at least one work share process.

3. The method of claim 1, wherein the method is advertised as “free” to the plurality of users.

4. The method of claim 1, wherein the mailer is generated and delivered to the postal authority within 24 hours of the mailer demand.
